(19) United States
(12) Patent Application Publication
(10) Pub. No.: US 2007/0047572 A1
(43) Pub. Date: Mar. 1, 2007

(54) Explicit flow control in Gigabit/10 Gigabit Ethernet system

(75) Inventors: Shailendra S. Desai, San Jose, CA (US); Mark D. Hayter, Menlo Park, CA (US)

Correspondence Address: MEYERTONS, HOOD, KIVLIN, KOWERT & GOETZEL, P.C., 700 LAVACA, SUITE 800, AUSTIN, TX, 78701, US

(73) Assignee: P.A. Semi, Inc., Santa Clara, CA (US)

(21) Appl. No.: 11/211,259

(22) Filed: Aug. 25, 2005

(51) Int. Cl. H04L 12/66; H04J 3/16

(52) U.S. Cl. 370/463; 370/469

(57) ABSTRACT

In one embodiment, a system comprises a communication medium; a first controller coupled to the communication medium; and a second controller coupled to the communication medium. The first controller is configured to interrupt transmission of a packet on the communication medium to the second controller subsequent to transmission of a first portion of the packet. The first controller is configured to transmit at least one control symbol on the communication medium in response to interrupting transmission of the packet, and wherein the first controller is configured to continue transmission of the packet with a second portion of the packet. The controller(s) may include, in some embodiments, a media access controller and a physical coding sublayer.

### BACKGROUND

1. Field of the Invention

This invention is related to the field of network communication and especially Ethernet communication, and more particularly to flow control on networks.

2. Description of the Related Art

Networking of computers and other electronic devices has become ubiquitous. While a variety of networking standards exist, Ethernet is one of the most popular. In particular, Gigabit Ethernet and 10 Gigabit Ethernet is becoming widely used.

The Ethernet standard currently does not permit the interruption of transmission of a packet. That is, once the first byte of a packet is transmitted on the communication media, the transmission must continue with consecutive bytes to the last byte of the packet without any “bubbles” or wait states in the transmission on the communication media (e.g. twisted pair copper wiring, optical fiber, etc.). If the source of the packet cannot supply all of the bytes of a packet, the packet is terminated and the receiver drops the packet as a bad packet.

As the bandwidth of the network interfaces has increased, the likelihood that other factors in a system become bottlenecks to transmission has also increased. For example, memory latency (in reading packets for transmission or writing packets that have been received) can become an issue. Contention for access to the memory (e.g. by processors or other devices in a host system) increases the effective memory latency, further exacerbating the effect.

Memory latency on the transmit side to read the packet from memory may be an issue since the packet may not be read quickly enough for complete transmission without any delays. Buffering in the network controller may be used to mitigate this effect, but it may not be feasible to include enough buffering in some cases. While the Ethernet standard specifies a maximum packet size of about 1500 bytes, many products implement larger packet sizes (e.g. 9 kilobytes or 16 kilobytes). Bandwidth is wasted by transmitting packets that must be dropped because the source cannot complete the transmission.

Similarly, memory latency on the receive side may prevent writing the packet data successfully to memory before a buffer in the network controller (or elsewhere in the system) overflows. The Ethernet standard (and particularly Institute of Electrical and Electronic Engineers (IEEE) specification 802.3) permits the use of a flow control packet by a receiver. The flow control packet, which is also referred to as a pause packet, can be transmitted from a receiver to the transmitter if the receiver is temporarily unable to receive packets. The flow control packet directs the transmitter to cease transmission of any packets to the receiver for a period of time specified in the packet. The transmitter may transmit up to two more packets, and then ceases packet transmission for the requested time. The flow control packet can be used to avoid dropping packets at the receiver. For example, if memory latency is causing the receiver to be unable to receive packets, the flow control packet can be used to insert delay in packet transmission so that the memory system can “catch up”. However, the transmitter can transmit up to two more packets (each of which may be, e.g., up to 16 kilobytes in size) before the flow control takes effect. These packets can be dropped by the receiver if memory latency is an issue.

Quality of service (QOS) metrics are becoming increasingly common on networks. Users can pay for different levels of service. Users for which low bandwidth communication is sufficient and for which communication latency is a lesser issue can pay for low priority service. For other users requiring higher bandwidth and/or dedicated bandwidth, higher priority service can be purchased (typically at higher prices). To manage different levels of service, the network controllers implement separate buffers, or queues, for the different levels. The buffers can be even further subdivided according to user, transmitter, receiver, etc. To abstract the various divisions, a set of channels may be supported and priorities may be assigned to each channel.

### SUMMARY

In one embodiment, a system comprises a communication medium; a first controller coupled to the communication medium; and a second controller coupled to the communication medium. The first controller is configured to interrupt transmission of a packet on the communication medium to the second controller subsequent to transmission of a first portion of the packet. The first controller is configured to transmit at least one control symbol on the communication medium in response to interrupting transmission of the packet, and wherein the first controller is configured to continue transmission of the packet with a second portion of the packet.

In another embodiment, a controller is configured to communicate packets on a communication medium. The controller comprises a media access controller (MAC) configured to transmit a packet as a plurality of bytes and a physical coding sublayer (PCS) circuit coupled to receive the plurality of bytes from the MAC. The PCS circuit is configured to encode each byte as a respective data symbol for transmission on the communication medium. The MAC is configured to interrupt transmission of the packet subsequent to transmitting a first portion of the plurality of bytes. The PCS circuit is configured to transmit a corresponding data symbol for each byte of the first portion and to transmit at least one control symbol in response to the interruption. The MAC is also configured to continue transmission of a second portion of the plurality of bytes, and the PCS circuit is configured to transmit corresponding data symbols for each byte of the second portion.

In other embodiments, a method comprises interrupting transmission of a packet on a communication medium. The packet comprises a plurality of bytes, and the interrupting is subsequent to transmitting a first portion of the plurality of bytes. Transmitting the first portion comprises encoding each byte of the first portion as a corresponding data symbol. Responsive to the interrupting, the method further comprises transmitting at least one control symbol on the communication medium. Transmission of the packet is continued with a second portion of the plurality of bytes, the transmission including encoding each byte of the second portion as a corresponding data symbol.

### BRIEF DESCRIPTION OF THE DRAWINGS

The following detailed description makes reference to the accompanying drawings, which are now briefly described.

FIG. 1 is a block diagram of one embodiment of a system including one embodiment of a pair of network interface controllers and corresponding hosts.

FIG. 2 is a block diagram of one embodiment of an interface between a media access controller and a physical coding sublayer.

FIG. 3 is a block diagram of another embodiment of an interface between a media access controller and a physical coding sublayer.

FIG. 4 is a flowchart illustrating operation of one embodiment of a media access controller for transmitting a packet.

FIG. 5 is a flowchart illustrating operation of one embodiment of a physical coding sublayer for transmitting a packet.

FIG. 6 is a flowchart illustrating operation of one embodiment of a physical coding sublayer for receiving a packet.

FIG. 7 is a timing diagram illustrating an example of operation of an interface shown in FIG. 2.

FIG. 8 is a timing diagram illustrating an example of transmission of symbols on Gigabit Ethernet.

FIG. 9 is a timing diagram illustrating an example of transmission of symbols on 10 Gigabit Ethernet.

FIG. 10 is a flowchart illustrating one embodiment of a media access controller for transmitting channel information.

FIG. 11 is a timing diagram illustrating an example of transmission of symbols including channel information on Gigabit Ethernet.

FIG. 12 is a timing diagram illustrating an example of transmission of symbols including channel information on 10 Gigabit Ethernet.

FIG. 13 is a timing diagram illustrating an example of transmission of symbols on 10 Gigabit Ethernet including interleaving of packets from different channels.

FIG. 14 is a flowchart illustrating one embodiment of auto negotiation.

While the invention is susceptible to various modifications and alternative forms, specific embodiments thereof are shown by way of example in the drawings and will herein be described in detail. It should be understood, however, that the drawings and detailed description thereto are not intended to limit the invention to the particular form disclosed, but on the contrary, the intention is to cover all modifications, equivalents and alternatives falling within the spirit and scope of the present invention as defined by the appended claims.

### DETAILED DESCRIPTION OF EMBODIMENTS

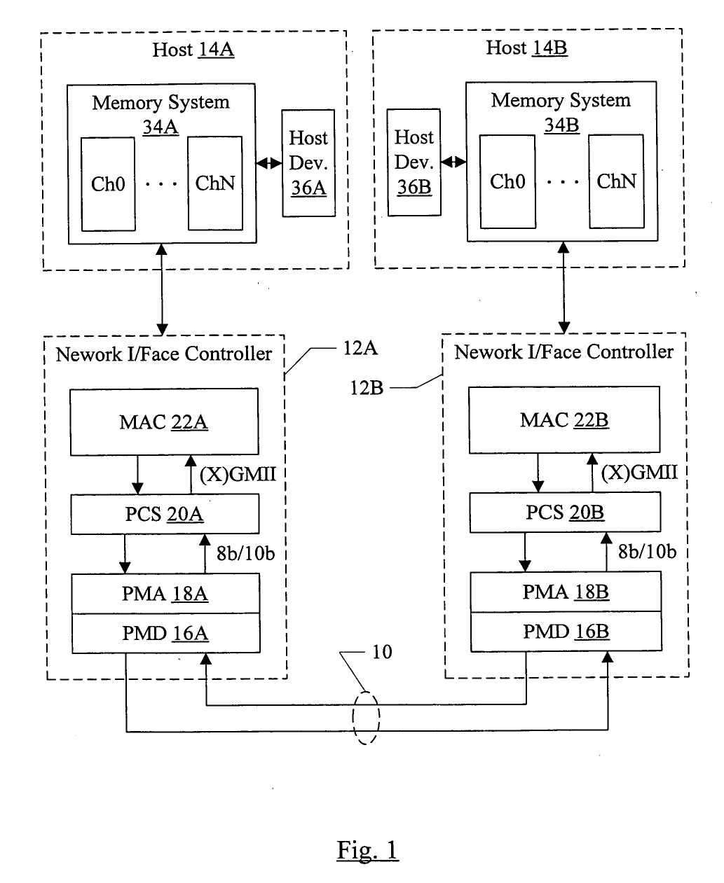

Turning now to FIG. 1, one embodiment of a networked system is shown. In the illustrated embodiment, the system includes a communication medium 10 over which network communications may be transmitted, network interface controllers 12A-12B coupled to the communication medium 10, and hosts 14A-14B coupled to the network interface controllers 12A-12B, respectively. In the illustrated embodiment, the network interface controller 12A includes a physical media dependent (PMD) layer 16A, a physical media attach (PMA) layer 18A, a physical coding sublayer (PCS) circuit 20A, and a media access controller (MAC) 22A. The PMD 16A is coupled to the communication medium 10 and to the PMA 18A, which is further coupled to the PCS 20A. The PCS 20A is coupled to the MAC 22A. The network interface controller 12B similarly includes a MAC 22B, PCS 20B, PMA 18B, and PMD 16B. The host 14A includes a memory system 34A and may also include other host devices such as host device 36A coupled to the memory system 34A. The host 14B may similarly include a memory system 34B and may also include other host devices such as host device 36B coupled to the memory system 34B. The memory systems 34A-34B may have various buffers or other memory regions for the channels supported for the packets (e.g. Ch0 to ChN in each of the memory systems 34A-34B in FIG. 1).

The network interface controllers 12A-12B (more briefly referred to below as controllers 12A-12B) are configured to transmit and receive packets on the communication medium 10. The network interface controllers 12A-12B may be link partners for each other on the communication medium 10. A link partner may include any device coupled to a communication medium 10 with a given device and capable of communicating over the communication medium 10 with the given device. In Gigabit/10 Gigabit (G/10 G) Ethernet, each physical link is established between a pair of devices which are link partners.

The controllers 12A-12B may be similar, and thus may operate in a similar fashion. The controller 12A (and portions thereof) will be described in more detail below, and the controller 12B may be similar. The controller 12B will thus be the link partner in this example.

The controller 12A may be configured to associate a channel with a given packet. On packet transmission, the channel is specified by software, by storing the packet in memory locations assigned to the channel. The controller 12A may select a channel for transmission, and may read the next packet to be transmitted on that channel from the memory system 34A. Alternatively, the host 14A may include direct memory access (DMA) circuitry that may select the channel and fetch the packet from the memory system 34A to the controller 12A (or the controller 12A may include the DMA circuitry). For packet reception, the controller 12A may include programmable packet classification filters (not shown) that may identify the channel for a received packet. The received packet may be written to memory locations in the memory system 34A assigned to that channel. Packets may include a channel ID field carrying the channel identifier, in some embodiments.

Generally, the MAC 22A may include the circuitry for transmitting packets on behalf of the host 14A, and for receiving packets on behalf of the host 14A. The MAC 22A may also include various other circuitry implementing MAC layer protocols and operations, as needed. The MAC 22A may be configured to transmit packets as a plurality of bytes and to receive packets as a plurality of bytes.

The PCS 20A is coupled to the MAC 22A, and provides the line coding/decoding for the packets being transmitted. For example, G/10 G Ethernet specifies 8 b/10 b encoding for the data transmission on the communication medium. Accordingly, the PCS 20A receives data from the MAC 22A for transmission (e.g. packets) and converts each 8 bit byte to a 10 bit symbol. Each 10 bit symbol received from the PMA 18A is converted to the corresponding 8 bit byte and provided to the MAC 22A. In the illustrated embodiment, the Gigabit Media Independent Interface (GMII) is used between the MAC and the PCS 20A. Other embodiments may use the 10 Gigabit MII (XGMII). Still other embodiments may use any other interface.

The PMA 18A receives 8 b/10 b symbols from the PCS and converts them for transmission on the physical communication medium 10, and converts received signals to the 8 b/10 b symbols. For example, the symbols may be serially transmitted on one or more lanes of the communication medium 10. The PMD 16A includes the circuitry that physically drives and receives on the communication medium 10.

The communication medium 10 may comprise any medium over which packets may be transmitted between link partners. For example, in one embodiment, twisted pair copper cabling may be used. In another embodiment, optical fiber interconnect may be used. For Gigabit Ethernet, one lane of twisted pair or optical fiber may be provided in each direction. For 10 G Ethernet, 4 lanes of optical fiber may be used in each direction typically, although twisted pair is also possible in some cases. Other communication media may be used in other embodiments. Still further, wireless communication media (e.g. broadcast in the air) may be used.

The 8 b/10 b symbol code space may be divided into data symbols and control symbols. Data symbols are symbols that represent particular data values. Each possible data value of a byte is mapped to at least one of the data symbols. In one implementation, each data value maps to two data symbols. One of the two symbols is selected for transmission for a given data value dependent on other transmission factors. For a given byte, the PCS 20A may be configured to generate the corresponding data symbol. The control symbols may be used to transmit control information. For example, control symbols may be defined to represent the start of a packet and the end of a packet. An idle control symbol may be defined, which indicates that no data is being transmitted. The idle control symbol is defined to be transmitted between packets (that is, between the end of packet symbol for one packet and the start of packet symbol for the next packet). The idle control symbol is also used, in some embodiments, as a control symbol transmitted if packet transmission is interrupted, described in more detail below.

The MAC 22A may be configured to interrupt transmission of a packet during the transmission. That is, the MAC 22A transmits the packet as a plurality of bytes, and may interrupt the transmission subsequent to transmitting a first portion of the bytes (and prior to transmitting a second portion of the bytes). Each portion comprises at least one byte, and may comprise any number of bytes. The MAC 22A may interrupt a packet transmission multiple times, an thus there may be additional portions (i.e. a third portion, a fourth portion, etc.).

The PCS 20A, in response to an interruption of the packet, may be configured to generate at least one control symbol for transmission. In one embodiment, for example, idle control symbols may be generated by the PCS 20A until the MAC 22A resumes transmission of the packet (or another packet, in some embodiments). The controller 12A may have a defined transmission bandwidth (e.g. a dedicated transmission path on the communication medium 10, in the illustrated embodiments). The PCS 20A may generate idle symbols to fill the transmission bandwidth until the MAC 22A resumes transmission. In other embodiments, other control symbols may be generated. For example, another control symbol may be defined to indicate that the packet transmission is being paused, and will be resumed again. Such a control symbol may be transmitted by the PCS 20A. Still further, the end of packet symbol may be used, if the receiver otherwise is informed that the actual end of packet comes later. For example, some embodiments below may transmit a channel indication and a packet indication (start, middle, or end) with the start of packet symbol. The packet indication may indicate which portion of the packet is being transmitted.

The interface between the MAC 22A and the PCS 20A may include explicit signalling of the start and end of packets. For example, the GMII interface includes a data valid signal. Assertion of the data valid signal is currently interpreted as an implicit start of packet and deassertion of the data valid signal is currently interpreted as an implicit end of packet. By adding explicit start of packet and end of packet signalling, the data valid signal may be deasserted during packet transfer to interrupt the flow of packet bytes without causing the packet to terminate. The XGMII interface includes control values in the data transfer. An additional control value may be generated, or a current control value (such as idle) may be used. Alternatively, separate explicit start of packet and end of packet signalling may be used.

The MAC 22A may interrupt packet transmission in response to one or more events, in various embodiments. Any combination of sets of events may be implemented. One event may be the reception of a flow control packet from the link partner of the controller 12A (e.g. the controller 12B in the embodiment of FIG. 1). The MAC 22A may interrupt transmission of a packet in response to the flow control packet, and may inhibit transmission until the time period specified in the flow control packet expires. Another event may be the unavailability of the next bytes to be transmitted (e.g. the initial bytes of the second portion). For example, if the MAC 22A has not received the next bytes to be transmitted from the memory system 34A (e.g. due to memory latency or memory contention), the bytes may not be available. The MAC 22A may interrupt transmission of the packet until the next bytes become available. Yet another event, in some embodiments, may be to interleave a packet from another channel.

By interrupting packet transmission for a flow control packet, the controller 12A may reduce the incidence of dropped packets due to buffer overflow in the link partner, in some embodiments. Less buffering may be implemented for handling the flow controlled case, in some embodiments, since 2 additional packets are not transmitted by the controller 12A after receipt of the flow control packet. By interrupting packet transmission when bytes are temporarily unavailable, effects of memory latency/contention may be mitigated and the incidence of packet dropping due to memory latency in reading the packet may be reduced, in some embodiments. Interleaving packets from different channels may permit prioritizing higher priority packets over lower priority packets even during transmission of lower priority packets, without causing packet drop, in some embodiments. Furthermore, interleaving packets may, in some embodiments, simplify interfacing to a link partner that may bridge to an explicitly channelized interface such as the system packet interface, version 4 (SPI-4).

A flow control packet may generally be any packet which, when received in a device that communicates on the communication medium, is defined to cause the receiver to inhibit transmitting at least some packets to the initiator of the flow control packet. The flow control packet specified by the Ethernet standard, which includes a time field specifying the time interval during which packet transmission is to be inhibited, may be an example of a flow control packet. In another embodiment, a channelized flow control packet may be supported which specifies the time interval but also specifies the channels to which the flow control packet applies. In response to a channelized flow control packet, transmission of packets may be inhibited for the specified channels but permitted for other channels. The MAC 22A may interrupt transmission of a packet if the packet is in one of the specified channels. The channelized flow control packet may include a channel indication field, which may be coded to identify the channel(s) (e.g. a channel number, a list of channel numbers and optionally a number of channels in the list, a bit mask with a bit per channel that may be set to identify the channel, etc.).

The hosts 14A-14B may comprise any circuitry that uses the controllers 12A-12B to connect to a network (e.g. the communication medium 10 may be part of a network). As illustrated in FIG. 1, each host 14A-14B may include a respective memory system 34A-34B. The memory systems 34A-34B may comprise any semiconductor memory (e.g. random access memory (RAM) such as static RAM (SRAM), dynamic RAM (DRAM), synchronous DRAM (SDRAM), double data rate (DDR or DDR2) DRAM, Rambus DRAM, etc.). The memory systems 34A-34B may further comprise one or more memory controllers configured to interface to the memory. Additionally, the hosts 14A-14B may comprise any other desired circuitry, such as the host devices 36A-36B. The host devices 36A-36B may include processors, input/output (I/O) devices or interfaces, bridge circuits to other interfaces, caches, etc. The host devices 36A-36B may be coupled to the memory systems 34A-34B, and may create contention for access to the memory systems 34A-34B with the controllers 12A-12B. Such contention may lengthen effective memory latency for the controllers 12A-12B.

It is noted that, in addition to interrupting packet transmission as described above, the controller 12A may also terminate packet transmission (e.g. due to error, lengthy expected delay, or other reasons that may make dropping the packet desirable).

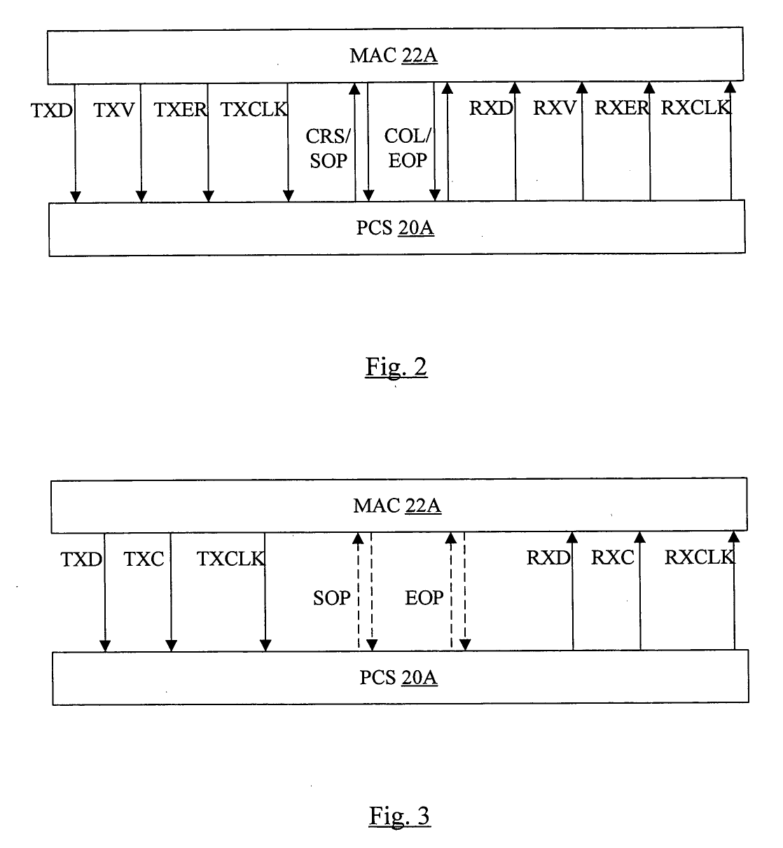

Turning now to FIG. 2, a block diagram of one embodiment of the MAC 22A and the PCS 20A, illustrating an interface therebetween for one embodiment of the controller 12A is shown. The interface of the embodiment of FIG. 2 may be compatible with the GMII interface, with extensions for explicit signalling of start and end of packets.

The interface illustrated in FIG. 2 includes a transmit (TX) data (TXD) bus, a TX valid (TXV) signal, a TX error (TXER) signal, and a TX clock (TXCLK) that is a clock reference for the transmit signals. The TXD bus may be one byte wide in one embodiment and transmits a packet data byte. The TXV signal may be asserted to indicate a valid packet data byte is being transmitted on TXD, and the TXER signal may be asserted to indicate an error in transmission. The TXV signal is also referred to as the TX enable (TXEN). The TXD, TXV, TXER, and TXCLK are sourced by the MAC 22A for transmitting packet data to the PCS 20A. A similar interface is used by the PCS 20A to provide received packet data bytes (decoded from the received 8 b/10 b symbols) and includes the receive (RX) data (RXD) bus, the RX valid (RXV) signal, the RX error (RXER) signal, and the RX clock (RXCLK) signal. Additionally, the carrier sense (CRS) and collision detect (COL) signals are provided as specified in the GMII interface for half duplex operation.

A start of packet (SOP) signal and an end of packet (EOP) signal are also provided to explicitly signal a start and end of a packet. The MAC 22A may assert the SOP signal along with the TXV signal for the initial byte of a transmitted packet, and may assert the EOP signal along with the TXV signal for the last byte of a transmitted packet. Thus, the TXV signal may be deasserted during packet transmission to interrupt the transmission of the packet. The PCS 20A may similarly use the SOP and EOP signals to signal the start and end of received packets, and may deassert the RXV signal to indicate that the packet being received has been interrupted. The MAC 22A may have separate SOP and EOP signals from the PCS 20A.

Since half duplex operation is not used in G/10 G Ethernet, the CRS and COL signals are not used. The signal lines carrying the CRS and COL signals may be reused as one of the SOP and EOP signals, in this embodiment.

FIG. 3 is a block diagram of another embodiment of the MAC 22A and the PCS 20A, illustrating an interface therebetween for another embodiment of the controller 12A. The interface of the embodiment of FIG. 3 may be compatible with the XGMII interface, with optional extensions for explicit signalling of start and end of packets.

The XGMII interface specifies 32 bit TX and RX data buses (TXD and RXD buses in FIG. 3) and a corresponding control bit (TXC and RXC buses) for each byte of the corresponding data bus (that is, 4 bits of control for each data bus). The interface further includes a clock in either direction (TXCLK and RXCLK). The control bit is set to indicate that the corresponding byte is a control byte, and clear to indicate that the corresponding byte is a data byte. Control bytes include start (start of packet), terminate (end of packet), idle, and error.

Thus, the MAC 22A may use the start and terminate bytes as explicit start and end of packet indications. Alternatively, the SOP and EOP control signals may be included (dashed lines in FIG. 3). The MAC 22A may use the idle control byte to interrupt packet transmission. The PCS 20A may similarly signal the start and end of received packets using the start and terminate control bytes, and may use idle control bytes to signal an interruption in packet transfer.

It is noted that, while an explicit start of packet and end of packet indication are included in the interfaces of FIGS. 2 and 3, other embodiments may include only an explicit end of packet indication, if desired. The start of packet indication may be implicit in the assertion of the data valid signal subsequent to the end of packet indication.

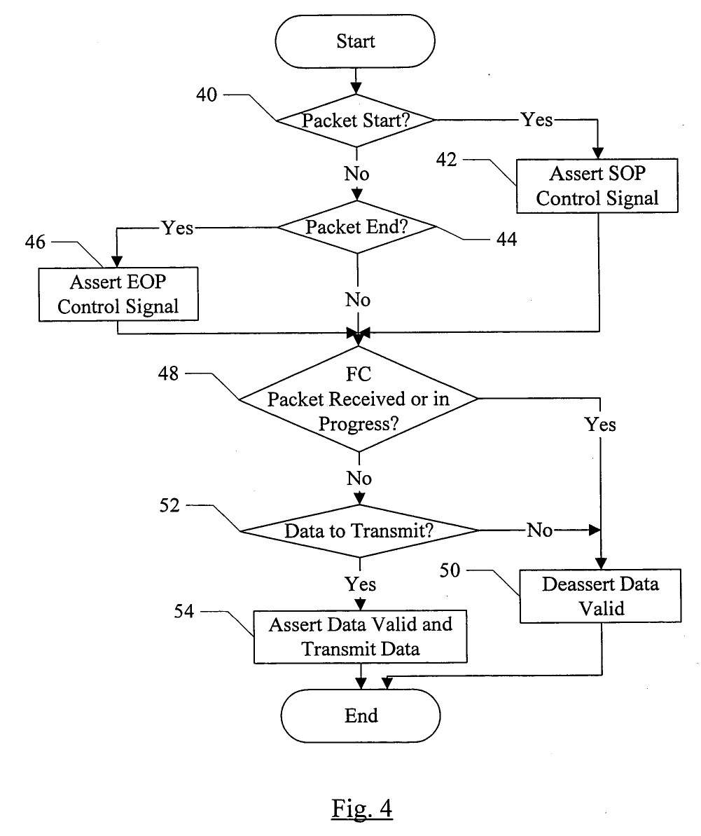

Turning now to FIG. 4, a flowchart is shown illustrating operation of one embodiment of the MAC 22A for packet transmission using the interface shown in FIG. 2. While the blocks are shown in a particular order for ease of understanding, other orders may be used. Blocks may be performed in parallel in combinatorial logic within the MAC 22A. Blocks, combinations of blocks, for the flowchart as a whole may be pipelined over multiple clock cycles.

If the MAC 22A is initiating a packet transmission (decision block 40, “yes” leg), the MAC 22A may assert the SOP control signal (block 42). Similarly, if the MAC 22A has reached the end of a packet transmission or is terminating for another reason (decision block 44, “yes” leg), the MAC 22A may assert the EOP control signal (block 46). If the MAC 22A receives a flow control (FC) packet or has a flow control in progress from a previously received FC packet (decision block 48, “yes” leg), the MAC 22A may deassert the data valid (TXV) signal even if the MAC 22A has data to transmit (block 50). In this fashion, packet transmission may be interrupted and inhibited during the time interval requested by the FC packet. If no FC packet has been received or is in progress, and the MAC 22A has no data to transmit (decision block 52, “no” leg), the MAC 22A may also deassert the data valid (TXV) signal (block 50). Thus, packet transmission may be interrupted if no data is ready to be transmitted. If there is no FC packet received or in progress and there is data ready to be transmitted, the MAC 22A may assert the data valid (TXV) signal and transmit the data (block 54).

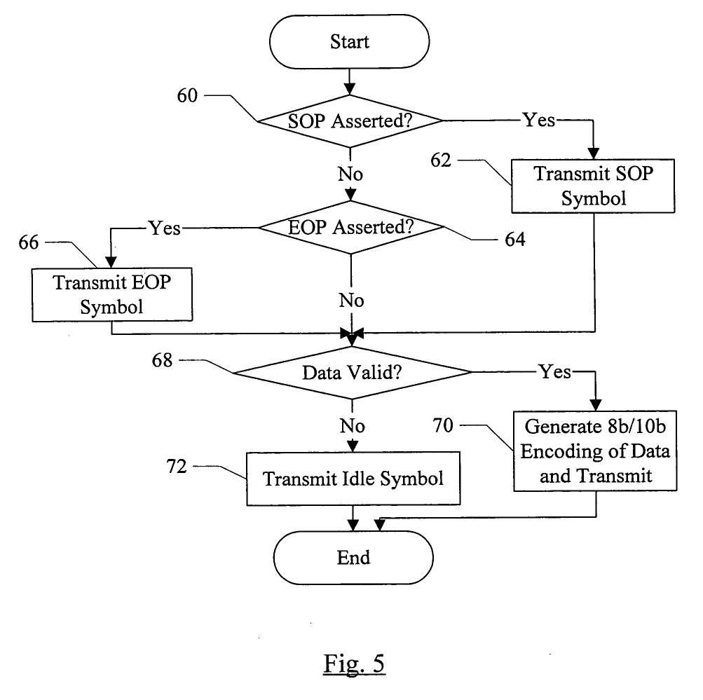

Turning now to FIG. 5, a flowchart is shown illustrating operation of one embodiment of the PCS 20A for packet transmission using the interface shown in FIG. 2. While the blocks are shown in a particular order for ease of understanding, other orders may be used. Blocks may be performed in parallel in combinatorial logic within the PCS 20A. Blocks, combinations of blocks, for the flowchart as a whole may be pipelined over multiple clock cycles.

If the SOP signal is asserted by the MAC 22A (decision block 60, “yes” leg), the PCS 20A may transmit the SOP control symbol to the PMA 18A for transmission on the communication medium 10 (block 62). Similarly, if the EOP signal is asserted (decision block 64, “yes” leg), the PCS 20A may transmit the EOP control symbol to the PMA 18A (block 66). If the data valid (TXV) signal is asserted by the MAC 22A (decision block 68, “yes” leg), the PCS 20A may generate the 8 b/10 b encoding of the data (that is, the corresponding data symbol) and transmit the data symbol to the PMA 18A (block 70). If the data valid signal is not asserted by the MAC 22A (decision block 68, “no” leg), the PCS 20A may transmit the idle control symbol (block 72). Thus, the idle control symbol may be transmitted during times that a packet is interrupted, as well as between packets, in this embodiment.

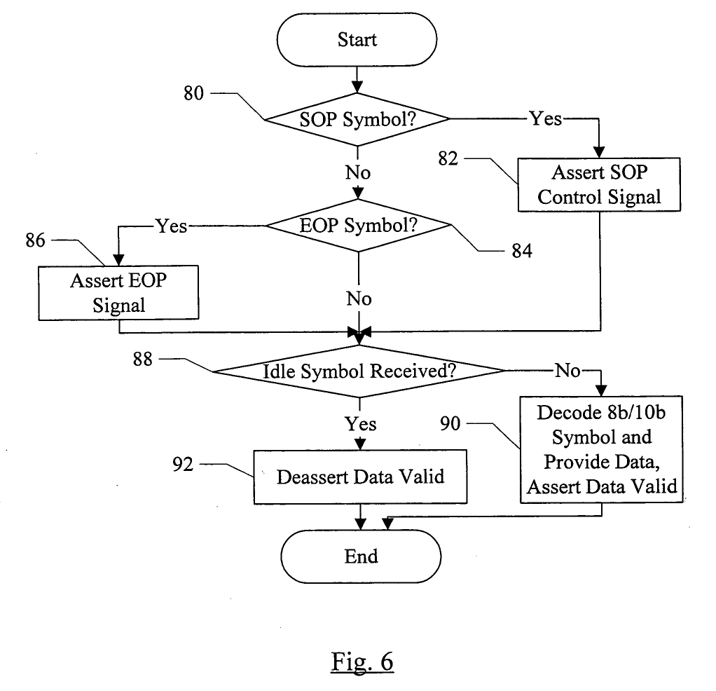

Turning now to FIG. 6, a flowchart is shown illustrating operation of one embodiment of the PCS 20A for receiving a packet using the interface shown in FIG. 2. While the blocks are shown in a particular order for ease of understanding, other orders may be used. Blocks may be performed in parallel in combinatorial logic within the PCS 20A. Blocks, combinations of blocks, for the flowchart as a whole may be pipelined over multiple clock cycles.

If the PCS 20A receives an SOP control symbol from the PMA 18A (decision block 80, “yes” leg), the PCS 20A may assert the SOP control signal to the MAC 22A (block 82). Similarly, if the PCS 20A receives an EOP control symbol from the PMA 18A (decision block 84, “yes” leg), the PCS 20A may assert the EOP control signal to the MAC 22A (block 86). If an idle symbol is received from the PMA 18A (decision block 88, “yes” leg), the PCS 20A may deassert the data valid (RXV) signal to the MAC 22A (block 92). The MAC 22A may ignore the data on the RXD bus and await the next assertion of the data valid (RXD) signal. Otherwise, the PCS 20A may decode the data symbol and provide the data on the RXD bus, asserting the data valid (RXV) signal (block 90).

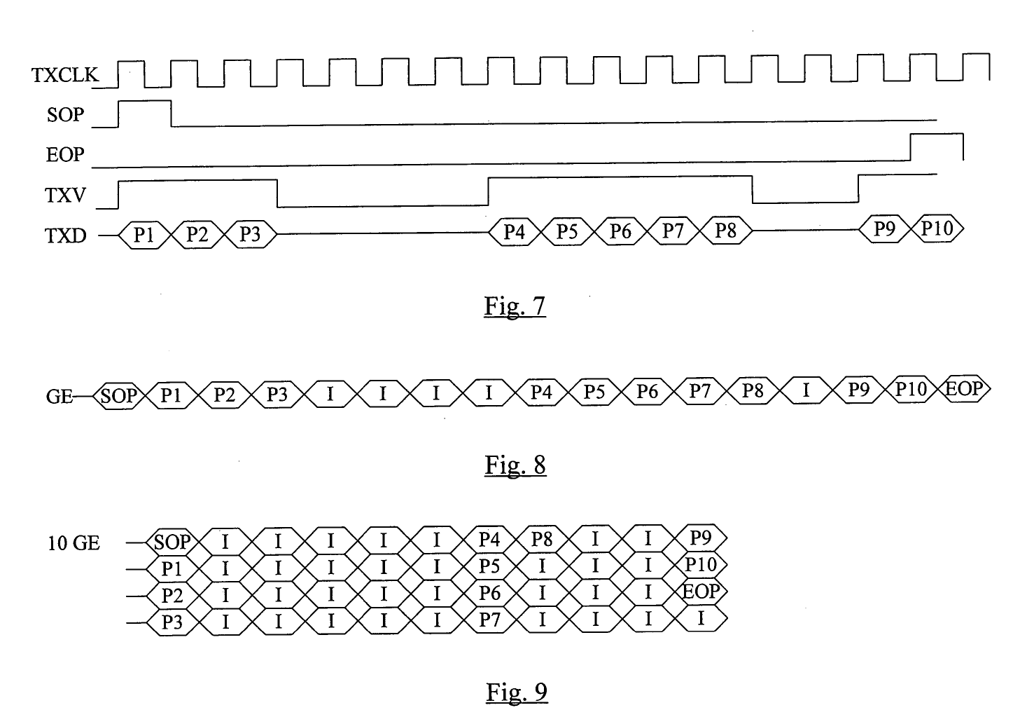

It is noted that the flowcharts of FIGS. 4-6 and the timing diagrams of FIGS. 7-9 using the extended GMII interface of the embodiment of FIG. 2. Other embodiments may use the interface of FIG. 3. In such a case, asserting the SOP/EOP control signal may be replaced by transmitting the start/terminate control byte. Additionally, for embodiments implementing the XAUI 10 G interface, 4 parallel lanes of symbols are transmitted concurrently. The operation of the flowcharts of FIGS. 4-6 may apply to each byte/symbol independently.

Turning next to FIG. 7, a timing diagram is shown illustrating an example of transmitting a packet using the interface of the embodiment of FIG. 2. The TXCLK is illustrated, along with the SOP and EOP control signals, the TXV signal, and the packet data being transmitted. While only 10 bytes are shown in FIG. 7 for reasons of space and clarity in the drawing, it is noted that additional bytes may be included in a packet. The first 11 bytes of an Ethernet packet may comprise the preamble (10 bytes) and start of frame delimiter (1 byte) added by the MAC 22A to the packet data stored in memory.

The SOP signal is asserted coincident with the transmission of the initial byte of the packet (P1), and is then deasserted. The TXV signal is also asserted, and remains asserted for the transmission of two additional bytes (P2 and P3). The TXV signal is deasserted for 4 cycles of the TXCLK, and then reasserted for the transfer of 5 bytes (P4 to P8). The TXV signal is again deasserted for 2 cycles, then reasserted for the transfer of 2 more bytes (P9 to P10). The EOP signal is asserted coincident with the transmission of P10, signalling the end of the packet.

FIG. 8 is a timing diagram illustrating an example of transmission of the packet shown in FIG. 7 on Gigabit Ethernet. The scale of time in FIG. 8 is not intended to be the same as FIG. 7, nor is FIG. 8 necessarily aligned in time with FIG. 7. The SOP symbol is transmitted responsive to the assertion of the SOP control signal, followed by data symbols corresponding to bytes P1 to P3. The idle control symbol (I) is transmitted until the next bytes are available for transmission (e.g. four idle symbol transmissions in this example). The data symbols corresponding to bytes P4 to P8 are then transmitted, followed by an idle control symbol, the data symbols for bytes P9 and P10, and the EOP control symbol.

FIG. 9 is a timing diagram illustrating an example of transmission of the packet shown in FIG. 7 on 10 Gigabit Ethernet. The scale of time in FIG. 9 is not intended to be the same as FIG. 7, nor is FIG. 9 necessarily aligned in time with FIG. 7. The SOP symbol is transmitted on lane 0 responsive to the assertion of the SOP control signal. The data symbols corresponding to bytes P1 to P3 are transmitted at the same time on lanes 1 to 3. The idle control symbol (I) is transmitted on all lanes until the next bytes are available for transmission (e.g. five transmissions of idle symbols across all lanes in this example). The data symbols corresponding to bytes P4 to P7 are transmitted in parallel, followed by the data symbol for byte P8 on lane 0. Coincident with the transmission of the data symbol corresponding to byte P8 are idle symbols on lanes 1 to 3. That is, packet interruption need not necessarily occur on any particular boundary, in some embodiments. Additional transmissions of idle symbols across all lanes follow, until the transmission of bytes P9-P10 on lanes 0 and 1 and the EOP control symbol on lane 2.

As mentioned previously, in some embodiments, the MAC 22A may also be configured to interleave packets from different channels. In such embodiments, the MAC 22A may transmit bytes identifying the channel number for each set of bytes transmitted on the interconnect. The controller 12A may transmit an SOP control symbol to indicate that bytes of a packet are being transmitted. Another symbol identifying the bytes as the start, middle, or end of the corresponding packet may also be transmitted.

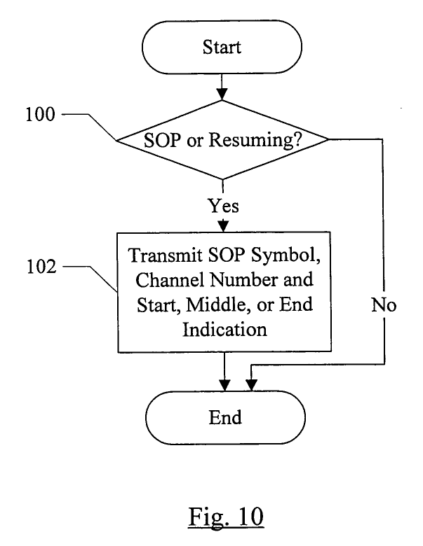

FIG. 10 is a flowchart illustrating additional operation of one embodiment of the MAC 22A/PCS 20A for interleaving packets from different channels. While the blocks are shown in a particular order for ease of understanding, other orders may be used. Blocks may be performed in parallel in combinatorial logic within the MAC 22A. Blocks, combinations of blocks, for the flowchart as a whole may be pipelined over multiple clock cycles.

If the transmission is the start of a packet or is the resumption of the packet after interruption (decision block 100, “yes” leg), the PCS 20A may transmit the SOP control symbol and the MAC 22A may prepend the packet data with the channel number and an indication of whether the bytes comprise the start, middle, or end of the packet (block 102). The bytes may be the start of the packet if they include the initial byte of the packet. The bytes may be the middle of the packet if they do not include the initial byte or the last byte of the packet. The bytes may be the middle of the packet if the include the last byte of the packet.

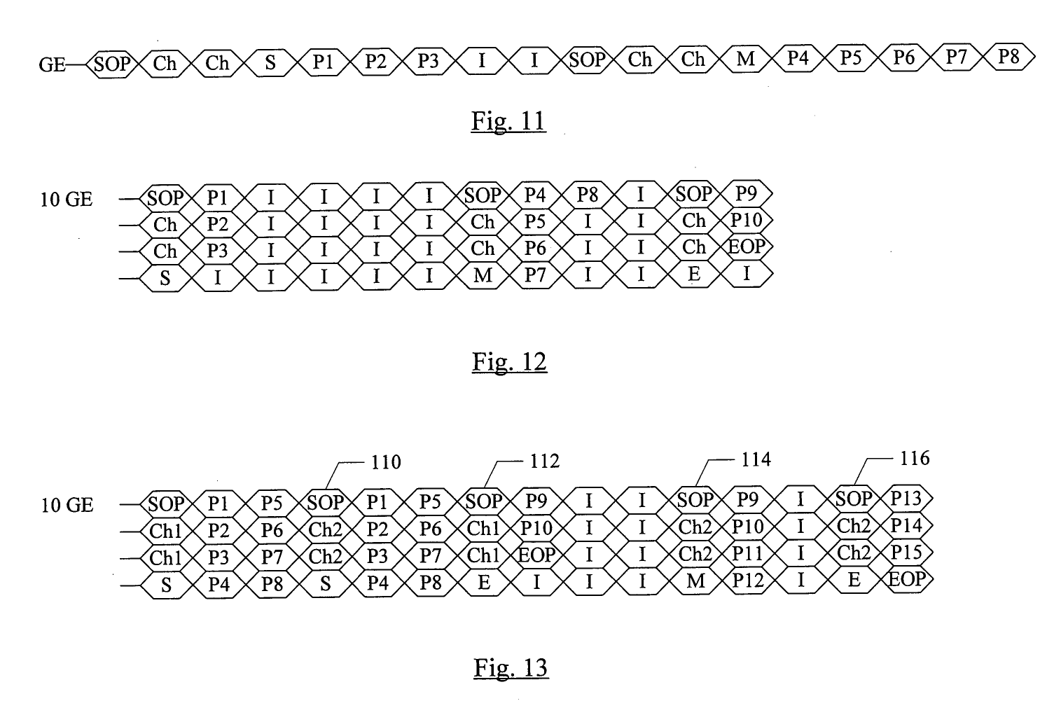

FIG. 11 is an example of one embodiment of transmitting a packet with channel information on Gigabit Ethernet, for a packet similar to the one illustrated in FIG. 7. The example includes the SOP control symbol, followed by two symbols that represent a two byte channel number, followed by a symbol indicating that the bytes that follow are the start of the packet (S in FIG. 11). Data symbols corresponding to three bytes follow (P1 to P3). After the symbol for byte P3, two idle control symbols follow because the packet is interrupted. The packet then resumes, with another SOP control symbol, followed by the channel number symbols and a symbol indicating the middle of the packet (M in FIG. 11). Five additional data symbols corresponding to bytes P4 to P8 are then transmitted. Not shown in FIG. 11 is at least one additional transfer of bytes that would include an indication of the end of the packet after the channel symbols.

FIG. 12 is an example of one embodiment of transmitting a packet with channel information on 10 Gigabit Ethernet for a packet similar to the one illustrated in FIG. 7. In this example, the SOP control symbol is transmitted on lane 0. Lanes 1 and 2 coincident with the SOP control symbol are the channel symbols, and lane 3 coincident with the SOP control symbol is the indication that the bytes are the start of the packet (S in FIG. 12). Data symbols for bytes P1 to P3 are transmitted in lanes 0 to 2, followed byte idle control symbols until the next portion of the packet is ready to be transmitted. Another SOP control symbol is transmitted, along with the channel symbols and the middle of packet indication (M in FIG. 12). Data symbols for bytes P4 to P8 are transmitted, followed by additional idle control symbols. Lastly, an SOP control symbol is transmitted, along with channel symbols and the end of packet indication (E in FIG. 12). The remaining data symbols corresponding to bytes P9 and P10 are transmitted and the EOP control symbol.

FIG. 13 is a timing diagram illustrating an example of interleaving packets from different channels on 10 Gigabit Ethernet. In the example of FIG. 13, a packet on a first channel (Chl) is started. The SOP control symbol is transmitted, along with the channel symbols representing Chl and the start of packet indication (S). Eight data symbols for the Chl packet are transmitted in the example (P1 to P8). The packet is then interrupted to transmit data from a different channel (Ch2). The SOP symbol is again transmitted (reference numeral 110), followed by the channel symbols representing Ch2 and the start of packet indication (S). Eight data symbols of the Ch2 packet are transmitted (P1 to P8). The Ch2 packet is interrupted, and the SOP control symbol is again transmitted (reference numeral 112). The channel symbols representing Ch1 and the end of packet indication (E) are transmitted coincident with the SOP control symbol. Data symbols for bytes P9 to P10 of the Ch1 packet are transmitted, and the EOP control symbol ending the Chl packet. Idle control symbols follow in the example, and then the SOP control symbol is transmitted (reference numeral 114). Coincident with the SOP control symbol, the channel symbols identify Ch2 and the packet indication indicates that the middle of the packet is being transmitted (M in FIG. 13). Data symbols for bytes P9 to P12 of the Ch2 packet are transmitted. After additional idle control symbols for another packet interruption, the SOP control symbol is transmitted (reference numeral 116). Coincident with the SOP control symbol, the channel symbols identify Ch2 and the packet indication indicates that the end of the packet is being transmitted (E in FIG. 13). Data symbols for bytes P13 to P15 of the Ch2 packet are transmitted, along with the EOP control symbol terminating the packet.

In some embodiments, each packet transmission that is interrupted may include an EOP control symbol as well as an SOP control symbol. Such transmissions may be compatible with link partners that do not implement the channel information and/or the flow controlling of packets on the communication medium 10. While two bytes/symbols are used for the channel number in the illustrated embodiment, other embodiments may use one byte/symbol or more than two bytes/symbols for the channel number. Additionally, the indication of start/middle/end of the packet may be transmitted before the channel symbols, if desired (e.g. on lane 1 instead of lane 3).

In one embodiment, the channel number symbols and the start/middle/end symbol may replace the first three bytes of the preamble of the packet. In G/10G Ethernet, the preamble is not really required, and so replacing the bytes should not affect functionality.

In some embodiments, the use of explicit flow control of packets (and/or transmission of channel information with packet data) may be enabled or disabled dependent on whether or not the link partner supports the features. For example, on Ethernet networks, an auto negotiation protocol is used at power up for link partners to determine each other's capabilities. After the standard auto negotiation, the link partners may exchange messages about other capabilities.

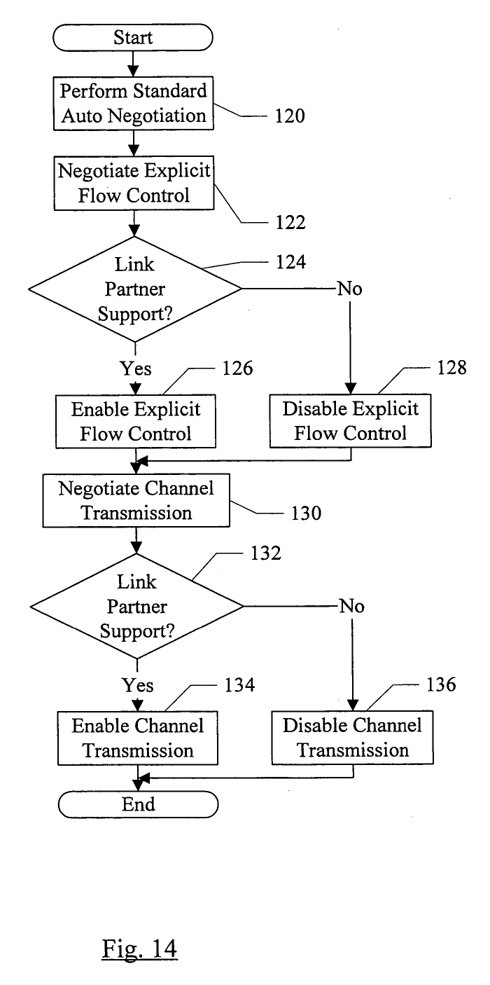

FIG. 14 is a flowchart illustrating operation of one embodiment of the controller 12A (and similarly controller 12B) for power up. While the blocks are shown in a particular order for ease of understanding, any order may be used. Furthermore, blocks may be performed in parallel in combinatorial logic within the controller 12A. Blocks, combinations of blocks, or the flowchart as a whole may be pipelined over multiple clock cycles.

The controller 12A may perform standard auto negotiation (block 120) followed by negotiation for explicit flow control (block 122). If the link partner supports explicit flow control (decision block 124, “yes” leg), the controller 12A may enable explicit flow control (block 126). Otherwise, the controller 12A may disable explicit flow control (block 128). The controller 12A may also negotiate for channel information transmission (block 130). If the link partner supports channel information transmission (decision block 132, “yes” leg), the controller 12A may enable channel information transmission (block 134). Otherwise, the controller 12A may disable channel information transmission (block 136).

Numerous variations and modifications will become apparent to those skilled in the art once the above disclosure is fully appreciated. It is intended that the following claims be interpreted to embrace all such variations and modifications.

1. A controller configured to communicate packets on a communication medium, the controller comprising:
a media access controller (MAC) configured to transmit a packet as a plurality of bytes; and
a physical coding sublayer (PCS) circuit coupled to receive the plurality of bytes from the MAC and configured to encode each byte as a respective data symbol for transmission on the communication medium;
wherein the MAC is configured to interrupt transmission of the packet subsequent to transmitting a first portion of the plurality of bytes, and wherein the PCS circuit is configured to transmit a corresponding data symbol for each byte of the first portion and to transmit at least one control symbol in response to the interruption, and wherein the MAC is configured to continue transmission of a second portion of the plurality of bytes, and wherein the PCS circuit is configured to transmit corresponding data symbols for each byte of the second portion.

2. The controller as recited in claim 1 wherein the PCS circuit is configured to transmit a plurality of control symbols including the at least one control symbol, the plurality of control symbols filling a transmission bandwidth of the controller on the communication medium between a last data symbol corresponding to the first portion and an initial data symbol corresponding to the second portion.

3. The controller as recited in claim 1 wherein the at least one control symbol comprises an idle control symbol that is also used between an end of one packet and a start of another packet on the communication medium.

4. The controller as recited in claim 1 wherein the MAC is configured to interrupt transmission of the packet responsive to the controller receiving a flow control packet from the communication medium, and wherein the MAC is configured to continue transmission with the second portion subsequent to inhibiting transmission for a period of time specified by the flow control packet.

5. The controller as recited in claim 1 wherein the MAC is configured to interrupt transmission of the packet responsive to the second portion being unavailable for transmission.

6. The controller as recited in claim 5 wherein the second portion is unavailable if the second portion has not yet been provided to the controller from a memory system to which the controller is coupled during use.

7. The controller as recited in claim 1 wherein the MAC is configured to interrupt transmission of the packet to interleave transmission of a second packet from a different channel.

8. The controller as recited in claim 1 wherein an interface between the MAC and the PCS circuit includes an explicit indication of an end of the packet, and wherein a lack of data transfer on the interface without the explicit indication causes the PCS circuit to transmit the at least one control symbol.

9. The controller as recited in claim 8 wherein the explicit indication comprises a control signal, and wherein the controller further comprises a second control signal to indicate a start of packet, and wherein the control signal and the second control signal are also used as a carrier sense signal and a collision detection signal in half duplex mode.

10. The controller as recited in claim 8 wherein the explicit indication comprises a combination of a control bit state and a corresponding data state on the interface.

11. A method comprising:
interrupting transmission of a packet on a communication medium, wherein the packet comprises a plurality of bytes, the interrupting subsequent to transmitting a first portion of the plurality of bytes, wherein the transmitting comprises encoding each byte of the first portion as a corresponding data symbol;
responsive to the interrupting, transmitting at least one control symbol on the communication medium; and
continuing transmission of the packet with a second portion of the plurality of bytes, the transmission including encoding each byte of the second portion as a corresponding data symbol.

12. The method as recited in claim 11 wherein transmitting at least one control symbol comprises transmitting a plurality of control symbols, the plurality of control symbols filling a transmission bandwidth of the controller on a communication medium between a last data symbol corresponding to the first portion and an initial data symbol corresponding to the second portion.

13. The method as recited in claim 11 wherein the at least one control symbol comprises an idle control symbol that is also used between an end of one packet and a start of another packet on the communication medium.

14. The method as recited in claim 11 wherein interrupting transmission of the packet is responsive to receiving a flow control packet from the communication medium, and wherein continuing transmission with the second portion is subsequent to inhibiting transmission for a period of time specified by the flow control packet.

15. The method as recited in claim 11 wherein interrupting transmission of the packet is responsive to the second portion being unavailable for transmission.

16. The method as recited in claim 11 wherein interrupting transmission of the packet is performed to interleave a second packet from a different channel.

17. A system comprising:
a communication medium;
a first controller coupled to the communication medium; and
a second controller coupled to the communication medium;
wherein the first controller is configured to interrupt transmission of a packet on the communication medium to the second controller subsequent to transmission of a first portion of the packet, and wherein the first controller is configured to transmit at least one control symbol on the communication medium in response to interrupt transmission of the packet, and wherein the first controller is configured to continue transmission of the packet with a second portion of the packet.

18. The system as recited in claim 17 wherein the first controller is configured to transmit a plurality of control symbols including the at least one control symbol, the plurality of control symbols filling a transmission bandwidth of the first controller on the communication medium between a last data symbol corresponding to the first symbol and an initial data symbol corresponding to the second portion.

19. The system as recited in claim 17 wherein the at least one control symbol comprises an idle control symbol that is also used between an end of one packet and a start of another packet on the communication medium.

20. The system as recited in claim 17 wherein the first controller is configured to interrupt transmission of the packet responsive to the controller receiving a flow control packet from the communication medium transmitted by the second controller, and wherein the first controller is configured to continue transmission with the second portion subsequent to inhibiting transmission for a period of time specified by the flow control packet.

21. The system as recited in claim 17 wherein the first controller is configured to interrupt transmission of the packet responsive to the second portion being unavailable for transmission.

22. The system as recited in claim 17 wherein the first controller is configured to interrupt transmission of the packet to interleave a second packet from a different channel.
